(19) United States
(12) Patent Application Publication
(10) Pub. No.: US 2026/0116168 A1
(43) Pub. Date: Apr. 30, 2026

(54) VEHICLE FRAMEWORK STRUCTURE

(71) Applicant: TOYOTA JIDOSHA KABUSHIKI KAISHA, Toyota-shi (JP)

(72) Inventor: Daisuke MOTOI, Sanda-sh (JP)

(21) Appl. No.: 19/332,059

(22) Filed: Sep. 18, 2025

(30) Foreign Application Priority Data
Oct. 24, 2024 (JP) 2024-187722

(51) Int. Cl. B60K 1/04; B62D 21/03; B62D 21/15; H01M 50/242; H01M 50/249

(52) U.S. Cl. CPC B60K 1/04; B62D 21/03; B62D 21/157; H01M 50/242; H01M 50/249; H01M 2220/20

(57) ABSTRACT

A vehicle framework structure, includes: a pair of framework members provided at respective end parts in a vehicle width direction and extending in a vehicle front-rear direction; a cross member provided between the pair of framework members and extending in the vehicle width direction; and a battery case disposed at a vehicle lower side of the cross member, in which: the framework members include an upper inner wall portion facing the cross member in the vehicle width direction and a lower inner wall portion facing the battery case in the vehicle width direction, and the upper inner wall portion is provided further toward an inner side in the vehicle width direction than the lower inner wall portion.

### CROSS-REFERENCE TO RELATED APPLICATION

This application is based on and claims priority under 35 USC 119 from Japanese Patent Application No. 2024-187722, filed on Oct. 24, 2024, the entire disclosure of which is incorporated by reference herein.

### BACKGROUND

### Technical Field

The present disclosure relates to a vehicle framework structure.

### Related Art

Japanese Patent Application Laid-open (JP-A) No. 2019-18760 (hereafter referred to as Patent Document 1) discloses a structure in which a battery case is provided under the floor of a vehicle. In the configuration described in Patent Document 1, a rocker is provided at both width direction end portions of a vehicle, a lower portion of the rocker faces the battery case, and an upper portion of the rocker is positioned higher than the floor panel. Note that the lower portion of the rocker described in Patent Document 1 is disposed further toward the vehicle width direction inner side than the upper portion.

If the lower portion of the rocker is disposed further toward the vehicle width direction inner side than the upper portion, as described in the above Patent Document 1, since the length in the vehicle width direction of the battery case is reduced, the installation amount of the battery cannot be increased. On the other hand, in cases in which the lower portion of the rocker is formed with a width that is approximately the same as the upper portion, it becomes difficult to satisfactorily maintain collision performance during a vehicle side-on collision.

### SUMMARY

The present disclosure provides a vehicle framework structure capable of securing a battery installation amount while also favorably maintaining collision performance at a time of a vehicle side-on collision.

A vehicle framework structure according to a first aspect includes: a pair of framework members provided at respective end parts in a vehicle width direction and extending in a vehicle front-rear direction; a cross member provided between the pair of framework members and extending in the vehicle width direction; and a battery case disposed at a vehicle lower side of the cross member, in which: the framework members include an upper inner wall portion facing the cross member in the vehicle width direction and a lower inner wall portion facing the battery case in the vehicle width direction, and the upper inner wall portion is provided further toward an inner side in the vehicle width direction than the lower inner wall portion.

In the vehicle framework structure according to the first aspect, a left and right pair of framework members are provided at respective vehicle width direction end portions, and the framework members each extend in the vehicle front-rear direction. A cross member extending in the vehicle width direction is provided between the pair of framework members, and a battery case is disposed below the cross member. Here, the framework member is configured including an upper inner wall portion facing the cross member in the vehicle width direction, and a lower inner wall portion facing the battery case in the vehicle width direction. The upper inner wall portion is provided further toward the vehicle width direction inner side than the lower inner wall portion. Thus, the lower inner wall portion is relatively positioned further toward the vehicle width direction outer side than the upper inner wall portion, thereby enabling the battery case to be expanded in the vehicle width direction to this extent.

The upper inner wall portion is positioned further toward the vehicle width direction inner side than the lower inner wall portion, and since the upper inner wall portion faces the cross member in the vehicle width direction, during a side-on collision of the vehicle (hereafter referred to as a “side-on collision” as appropriate), a collision load is transmitted to the cross member from the upper inner wall portion, and the collision load can be effectively transmitted to the non-collision side.

A vehicle framework structure according to a second aspect of the present disclosure is the first aspect, in which: the upper inner wall portion is disposed at a gap from the cross member, the lower inner wall portion is disposed at a gap from the battery case, and the gap between the upper inner wall portion and the cross member is smaller than the gap between the lower inner wall portion and the battery case.

In the vehicle framework structure according to the second aspect, since a gap is provided between the upper inner wall portion and the cross member, even in a configuration in which assembly with the framework members is performed in a state in which the cross member is fastened to the battery case, assembly can be completed without interference between the framework member and the cross member. Further, since a gap is provided between the lower inner wall portion and the battery case, input of the collision load to the battery case during a vehicle side-on collision can be suppressed.

Further, the gap between the upper inner wall portion and the cross member is smaller than the gap between the lower inner wall portion and the battery case. This enables the upper inner wall portion to contact the cross member before the lower inner wall portion contacts the battery case during a side-on collision of the vehicle, and the collision load can be transmitted through the cross member.

A vehicle framework structure according to a third aspect is the first aspect, in which an inclined portion, inclined from a vehicle width direction outer side to a vehicle width direction inner side on progression toward a vehicle upper part, is provided between the upper inner wall portion and the lower inner wall portion.

In the vehicle framework structure according to the third aspect, because an inclined portion is provided between the upper inner wall portion and the lower inner wall portion, when assembling the cross member with the framework member from the vehicle lower side, the inclined portion can function as a guide member, and the cross member can be positioned between the left and right pair of framework members.

A vehicle framework structure according to a fourth aspect is the third aspect, in which an upper end part of the inclined portion is provided at a position that overlaps with a lower end part of the cross member as viewed from the vehicle width direction.

In the vehicle framework structure according to the fourth aspect, since a collision load is transmitted to the cross member from the upper end of the inclined portion, at which the thickness in the vehicle width direction is thicker, local deformation of the framework member can be suppressed.

A vehicle framework structure according to a fifth aspect is the third aspect, in which a lower end part of the inclined portion is positioned further toward a vehicle upper part than a terminal member of a battery housed inside the battery case.

In the vehicle framework structure according to the fifth aspect, even in a case in which the framework member has entered the battery case during a side-on collision, interference of the terminal member of the battery with the inclined portion can be suppressed.

As explained above, the vehicle framework structure according to the present disclosure enables the installation amount of the battery to be secured while favorably maintaining collision performance at a time of a vehicle side-on collision.

### BRIEF DESCRIPTION OF THE DRAWINGS

Exemplary embodiments of the present disclosure will be described in detail based on the following figures, wherein:

FIG. 1 is a schematic plan view illustrating a framework of a vehicle to which a vehicle framework structure according to a first exemplary embodiment is applied;

FIG. 2 is an enlarged cross-section showing an enlarged state sectioned along line 2-2 in FIG. 1; and

FIG. 3 is an enlarged cross-section of relevant portions illustrating the rocker of FIG. 2 in an enlarged manner.

### DETAILED DESCRIPTION

Explanation follows regarding a vehicle framework structure according to an exemplary embodiment, with reference to the drawings.

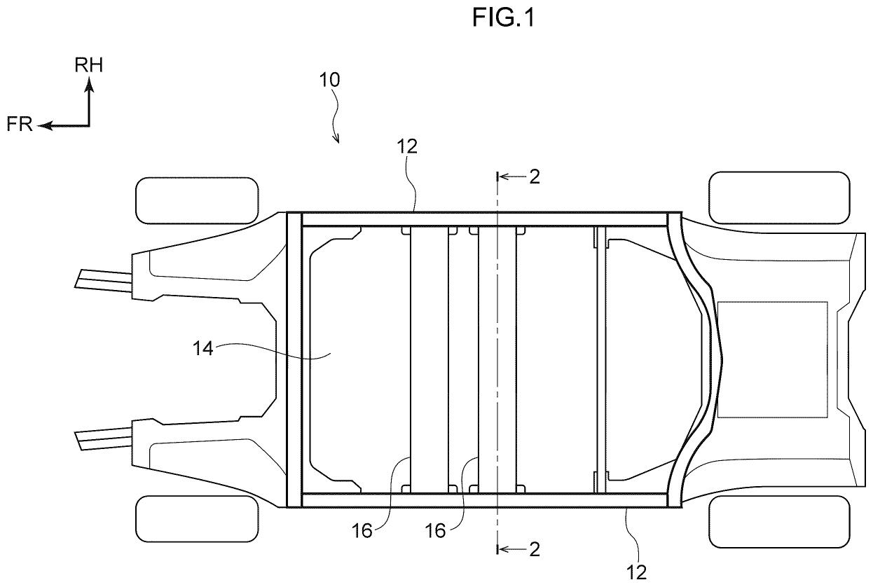

FIG. 1 is a schematic plan view illustrating a framework of a vehicle 10 to which a vehicle framework structure according to an exemplary embodiment is applied. Note that in the drawings, the arrow FR, the arrow UP, and the arrow RH respectively indicate the vehicle forward direction, the vehicle upward direction, and the vehicle rightward direction of the vehicle 10. Unless specifically stated otherwise, in the following explanation, reference to the front and rear, up and down, and left and right directions refers to front and rear in the vehicle front-rear direction, up and down in the vehicle vertical direction, and left and right in the vehicle left-right direction (width direction), respectively.

As illustrated in FIG. 1, a vehicle 10 of the present exemplary embodiment includes rockers 12 as a left and right pair of framework members. The rockers 12 are provided at both vehicle width direction end portions of the vehicle 10, and each of the rockers 12 extends in the vehicle front-rear direction.

A cross member 16 is provided between the left and right rockers 12. In the present exemplary embodiment, as an example, two cross members 16 are disposed, at the front and rear, each extending in the vehicle width direction. A seat, not illustrated in the drawings, configuring a driver seat, a passenger seat, or the like, is attached to the cross member 16.

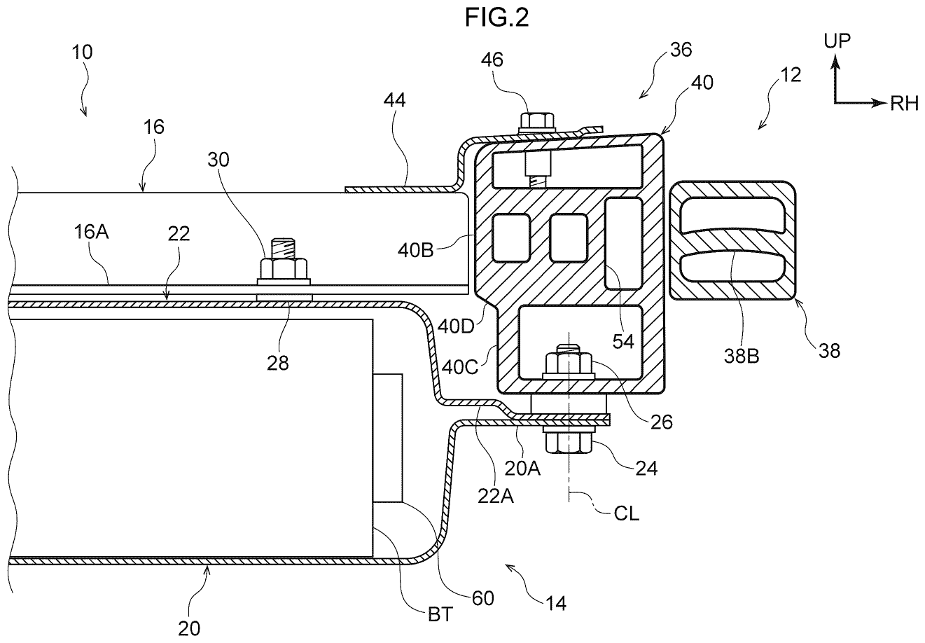

A battery case 14 is disposed at a vehicle lower side of the cross member 16. The battery case 14 is a case that protects a battery BT (see FIG. 2) housed inside the case. Details of the battery case 14 will be described later.

FIG. 2 is an enlarged cross-section showing an enlarged state sectioned along line 2-2 in FIG. 1. As illustrated in FIG. 2, the battery case 14 is disposed below the floor of the vehicle 10, and is configured including a case lower 20 and a case upper 22.

The case lower 20 is formed with a substantially hat-shaped cross-section that is open at the vehicle upper side as viewed from the vehicle front-rear direction, and a lower side flange 20A is formed at both vehicle width direction end portions of the case lower 20. Further, the case upper 22 is formed with a substantially hat-shaped cross-section that is open at the vehicle lower side as viewed from the vehicle front-rear direction, and an upper side flange 22A is formed at both vehicle width direction end portions of the case upper 22. The lower side flange 20A and the upper side flange 22A are fastened together by a bolt 24 in an overlapping state. The bolt 24 is screwed to a nut 26 provided at a first energy absorption member 36 configuring the rocker 12.

A battery BT is housed in the battery case 14. The battery BT is configured so as to be capable of supplying electric power to a drive source of the vehicle 10, such as a motor, not illustrated in the drawings. A terminal member 60 is provided at an end portion of the battery BT. The terminal member 60 is a bus bar formed of metal, and electrically connects battery cells configuring the battery BT.

A cross member 16 is provided above the case upper 22 of the battery case 14. The cross member 16 is formed with a substantially hat-shaped cross-section that is open at the vehicle lower side as viewed from the vehicle width direction, and a flange 16A is formed at each front and rear end part of the cross member 16.

The flange 16A of the cross member 16 is overlapped with the case upper 22 of the battery case 14, and is fastened to the battery case 14 by a stud bolt 28 and a nut 30. There is no particular limitation on fastening portions between the cross member 16 and the battery case 14, and they are fastened at four locations at regular intervals along the vehicle width direction, for example.

Explanation follows regarding details of the rocker 12, which is a relevant portion of the present disclosure.

The rocker 12 is mainly configured including a first energy absorption member 36 and a second energy absorption member 38. The rocker 12 is configured including a rocker inner panel and a rocker outer panel, not illustrated in the drawings, serving as an outer shell, and a first energy absorption member 36 and a second energy absorption member 38 are disposed in a closed cross-section configured by the rocker inner panel and the rocker outer panel.

The first energy absorption member 36 is disposed at an inner side in the vehicle width direction of the rocker 12, and includes a hollow main body portion 40. The main body portion 40 and the cross member 16 are fastened together by a bracket 44. Although not illustrated in the drawings, the other rocker is similarly fastened to the cross member 16 by a bracket, and therefore, the one rocker 12 and the other rocker are connected by a cross member.

The bracket 44 of the present exemplary embodiment is formed in a substantial crank shape when viewed from the vehicle front-rear direction, and an inner side of the bracket 44 in the vehicle width direction is fastened by a fastening means, not illustrated in the drawings, in a state overlapping with the upper face of the cross member 16. An outer side of the bracket 44 in the vehicle width direction is fastened by a bolt 46 in a state overlapped with an upper face of the main body portion 40.

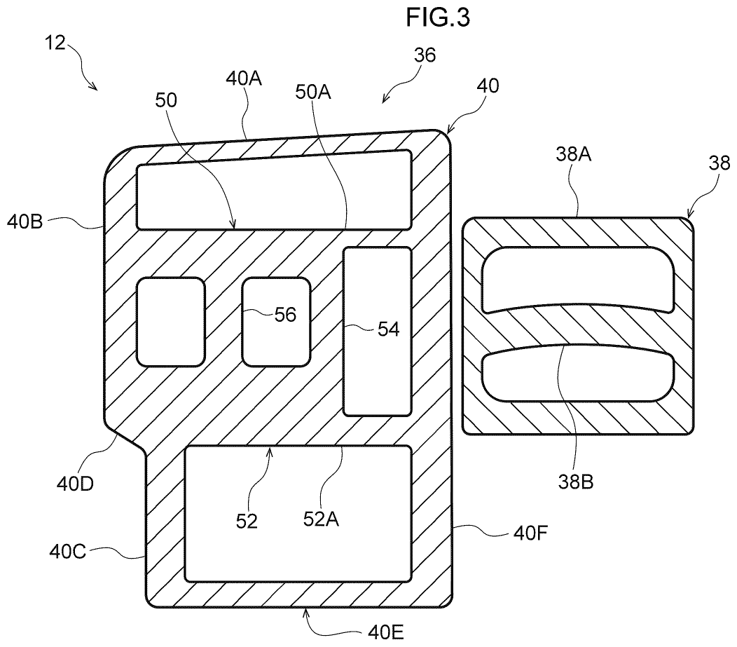

FIG. 3 is an enlarged cross-section of relevant portions illustrating the rocker of FIG. 2 in an enlarged manner. As illustrated in FIG. 3, the main body portion 40 is configured including an upper wall portion 40A, an upper inner wall portion 40B, a lower inner wall portion 40C, an inclined portion 40D, a lower wall portion 40E, and an outer wall portion 40F.

The upper wall portion 40A configures the upper face of the main body portion 40, and inclines downward from the vehicle width direction outer side toward the vehicle width direction inner side.

The upper inner wall portion 40B extends in the vehicle vertical direction and the vehicle front-rear direction, and an upper end portion of the upper inner wall portion 40B is connected to a vehicle width direction inner side end portion of the upper wall portion 40A. Further, a lower inner wall portion 40C is provided further toward the vehicle lower side than the upper inner wall portion 40B. The lower inner wall portion 40C extends in the vehicle vertical direction and in the vehicle front-rear direction, and an inclined portion 40D is provided between the upper inner wall portion 40B and the lower inner wall portion 40C.

The inclined portion 40D is inclined toward the vehicle upper side from the vehicle width direction outer side toward the vehicle width direction inner side. A lower end portion of the inclined portion 40D is connected to the lower inner wall portion 40C, and an upper end portion of the inclined portion 40D is connected to the upper inner wall portion 40B.

Note that the upper inner wall portion 40B is provided further toward the vehicle width direction inner side than the lower inner wall portion 40C. Thus, a side wall at the vehicle width direction inner side of the main body portion 40 is formed in a shape with a lower portion cut out. The upper inner wall portion 40B faces the cross member 16 in the vehicle width direction, and the lower inner wall portion 40C faces the battery case 14 in the vehicle width direction (see FIG. 2).

The lower wall portion 40E configures a lower face of the main body portion 40, and extends in the vehicle width direction and the vehicle front-rear direction. An inner side end portion of the lower wall portion 40E in the vehicle width direction is connected to a lower end of the lower inner wall portion 40C, and a vehicle width direction outer side end portion of the lower wall portion 40E is connected to a lower end of the outer wall portion 40F.

The outer wall portion 40F extends in the vehicle vertical direction and the vehicle front-rear direction, and an upper end portion of the outer wall portion 40F is connected to a vehicle width direction outer side end portion of the upper wall portion 40A.

An upper partition wall 50, a lower partition wall 52, an outer side vertical connection wall 54, and an inner side vertical connection wall 56 are provided inside the main body portion 40. Further, a partition part of the present disclosure is configured including the upper partition wall 50 and the lower partition wall 52.

The upper partition wall 50 is disposed at an upper part of the main body portion 40, and extends in the vehicle width direction such that an outer wall positioned at the vehicle width direction outer side of the main body portion 40 and an inner wall positioned at the vehicle width direction inner side are connected in the vehicle width direction. The internal space of the main body portion 40 is divided into upper and lower parts by the upper partition wall 50. The lower partition wall 52 is disposed lower than the upper partition wall 50, and extends in the vehicle width direction. The internal space of the main body portion 40 is divided into upper and lower parts by the lower partition wall 52.

Here, the upper partition wall 50 is formed with a thicker wall thickness in the vehicle vertical direction at the vehicle width direction inner side than at the vehicle width direction outer side. Specifically, an upper change portion 50A at which the wall thickness changes is formed at a vehicle width direction outer side of a vehicle width direction center portion of the upper partition wall 50. As an example, in the present exemplary embodiment, the wall thickness at the right side of the upper partition wall 50 is set to a thickness of not more than one third of the wall thickness at the left side, with the upper change portion 50A as a boundary.

Similarly to in the upper partition wall 50, the lower partition wall 52 is formed with a thicker wall thickness in the vehicle vertical direction at the vehicle width direction inner side than at the vehicle width direction outer side. Specifically, a lower change portion 52A at which the wall thickness changes is formed at a vehicle width direction outer side of a vehicle width direction center portion of the lower partition wall 52. As an example, in the present exemplary embodiment, the thickness at the right side of the lower partition wall 52 is set to a thickness of not more than one third of the thickness at the left side, with the lower change portion 52A as a boundary. In the present exemplary embodiment, the upper change portion 50A and the lower change portion 52A are formed at positions that overlap each other when viewed from the vehicle vertical direction.

The upper change portion 50A and the lower change portion 52A are connected in the vehicle vertical direction by an outer side vertical connection wall 54. The outer side vertical connection wall 54 extends substantially vertically, and a wall thickness of the outer side vertical connection wall 54 is thicker than a thin portion of the upper partition wall 50, and is formed thinner than a thick portion thereof.

An inner side vertical connection wall 56 is provided further toward the vehicle width direction inner side than the outer side vertical connection wall 54. The inner side vertical connection wall 56 extends substantially parallel to the outer side vertical connection wall 54 in the vehicle vertical direction, and is of approximately the same thickness as the outer side vertical connection wall 54. A space surrounded by the upper side partition wall 50, the lower side partition wall 52, the outer side vertical connection wall 54, and the main body portion 40 is divided into left and right halves by the inner side vertical connection wall 56.

A second energy absorption member 38 with a closed cross-section structure is provided further toward the vehicle width direction outer side than the main body portion 40. The second energy absorption member 38 includes a hollow main body portion 38A, and an upper-lower partition wall 38B that partitions an internal space of the main body portion 38A into upper and lower parts, and in which a vehicle width direction center portion is curved upward or downward. As an example, in the present exemplary embodiment, the upper-lower partition wall 38B is provided at the vertical direction center portion of the second energy absorption member 38, and a vehicle width direction center portion is curved upward.

Here, the upper wall of the second energy absorption member 38 is disposed at a position that overlaps with the upper partition wall 50 of the first energy absorption member 36 as viewed from the vehicle width direction, and a lower wall of the second energy absorption member 38 is disposed at a position overlapping with the lower partition wall 52 of the first energy absorption member 36 as viewed from the vehicle width direction.

As illustrated in FIG. 2, the upper inner wall portion 40B is disposed with a gap between itself and the cross member 16. Further, the lower inner wall portion 40C is disposed with a gap between itself and the battery case 14.

Here, the gap between the upper inner wall portion 40B and the cross member 16 is set with a smaller size than the gap between the lower inner wall portion 40C and the battery case.

An upper end portion of the inclined portion 40D of the main body portion 40 is provided at a position that overlaps with a lower end portion of the cross member 16 as viewed in the vehicle width direction. A lower end portion of the inclined portion 40D is positioned further upward in the vehicle than the terminal member 60 housed in the battery case 14.

Further, the upper ridge line of the cross member 16 and the upper partition wall 50 of the first energy absorption member 36 are provided at the same height. In other words, the ridge line of the cross member 16 and the upper partition wall 50 are provided at positions that overlap with each other as viewed from the vehicle width direction. Here, the ridge line of the cross member 16 refers to a portion between the upper face and the front face of the cross member 16, and a portion between the upper face and the rear face of the cross member 16.

Further, a position of the flange 16A at the lower end of the cross member 16 and the lower partition wall 52 of the first energy absorption member 36 are disposed at the same height. In other words, the lower end of the cross member 16 and the lower partition wall 52 are provided at positions that overlap with each other when viewed from the vehicle width direction.

In addition, the outer side vertical connection wall 54 is provided at the vehicle width direction outer side of a center line CL of the fastening portion between the battery case 14 and the first energy absorption member 36. In other words, a fastening hole for fastening the battery case 14 and the rocker 12 is provided further toward the vehicle width direction inner side than the outer side vertical connection wall 54.

Next, explanation follows regarding the mechanism of the vehicle framework structure according to the present exemplary embodiment.

As illustrated in FIG. 1, the vehicle 10 to which the vehicle framework structure according to the present exemplary embodiment is applied includes a left and right pair of rockers 12 provided at both vehicle width direction end portions, and the rockers 12 each extend in the vehicle front-rear direction. Further, a cross member 16 extending in the vehicle width direction is provided between the pair of rockers 12, and the battery case 14 is disposed below the cross member 16.

As illustrated in FIG. 2, the first energy absorption member 36 configuring the rocker 12 is configured including an upper inner wall portion 40B facing the cross member 16 in the vehicle width direction, and a lower inner wall portion 40C facing the battery case 14 in the vehicle width direction. Further, the upper inner wall portion 40B is provided further toward the vehicle width direction inner side than the lower inner wall portion 40C. Since, as a result, the lower inner wall portion 40C is relatively positioned further toward the vehicle width direction outer side than the upper inner wall portion 40B, the battery case can be expanded in the vehicle width direction to this extent. Namely, more batteries BT can be installed than in a configuration in which the lower inner wall portion 40C is flush with the upper inner wall portion 40B.

Further, in the present exemplary embodiment, the upper inner wall portion 40B is positioned further toward the vehicle width direction inner side than the lower inner wall portion 40C, and the upper inner wall portion 40B faces the cross member 16 in the vehicle width direction. As a result, in the case of a side-on collision of the vehicle 10, the collision load is transmitted to the cross member 16 from the upper inner wall portion 40B, and the collision load can be effectively transmitted to the non-collision side.

In addition, in the present exemplary embodiment, since a gap is provided between the upper inner wall portion 40B and the cross member 16, even in a configuration in which the cross member 16 is assembled with the rocker 12 in a state in which the cross member 16 is fastened to the battery case 14, assembly can be accomplished without interference between the rocker 12 and the cross member 16.

Further, since a gap is provided between the lower inner wall portion 40C and the battery case 14, the input of a collision load to the battery case 14 during a side-on collision of the vehicle 10 can be suppressed.

In particular, in the present exemplary embodiment, the gap between the upper inner wall portion 40B and the cross member 16 is smaller than the gap between the lower inner wall portion 40C and the battery case 14. This enables the upper inner wall portion 40B to contact the cross member 16 before the lower inner wall portion 40C contacts the battery case 14 during a side-on collision of the vehicle 10, and the collision load can be transmitted through the cross member 16.

In addition, in the present exemplary embodiment, because the inclined portion 40D is provided between the upper inner wall portion 40B and the lower inner wall portion 40C, when assembling the cross member 16 with respect to the rocker 12 from the vehicle lower side, the inclined portion 40D can function as a guide member, and the cross member 16 can be positioned between the left and right pair of first energy absorption members 36 (the rockers 12).

Further, yet, in the present exemplary embodiment, since a collision load is transmitted to the cross member 16 from the upper end of the inclined portion 40D, where the thickness in the vehicle width direction is thicker, local deformation of the rocker 12 can be suppressed.

Further, in the present exemplary embodiment, since the lower end of the inclined portion 40D is disposed further toward the vehicle upper side than the terminal member 60, even in cases in which the first energy absorption member 36 has entered the battery case 14 during a side-on collision, interference of the terminal member 60 of the battery BT with the inclined portion 40D can be suppressed. Namely, a wide distance between the terminal member 60 and the rocker 12 can be secured, and collapse of the terminal member 60 during a side-on collision of the vehicle 10 can be suppressed.

Although a vehicle framework structure according to the present disclosure has been described above, it is, of course, the case that various embodiments can be practiced within a range that does not depart from the gist of the present disclosure. For example, in the present exemplary embodiment, the rocker 12 is configured including the first energy absorption member 36 and the second energy absorption member 38; however, there is no limitation to this, and the rocker 12 may be configured including only the first energy absorption member 36.

Further, in the present exemplary embodiment, a gap was provided between the upper inner wall 40B of the main body portion 40 and the cross member 16; however, there is no limitation to this, and the configuration may be such that the cross member 16 abuts against the upper inner wall portion 40B, for example. In such a case, after fastening the battery case 14 to the first energy absorption member 36, the cross member 16 may be disposed and directly coupled to the first energy absorption member 36.

In addition, in the present exemplary embodiment, the terminal member 60 of the battery BT is disposed further toward the vehicle lower side than the inclined portion 40D; however, there is no limitation to this, and at least a portion of the terminal member 60 may be disposed at a position overlapping with the inclined portion 40D when viewed from the vehicle width direction outer side.

Further, yet, in the present exemplary embodiment, an inclined portion 40D is provided between the upper inner wall portion 40B and the lower inner wall portion 40C; however, there is no limitation to this, and a stepped portion at a substantially right angle may be formed. However, from the perspective of suppressing stress concentration, it is preferable to provide the inclined portion 40D.

In relation to the foregoing exemplary embodiment, additional notes are disclosed below.

### ADDITIONAL NOTE 1

A vehicle framework structure, including:
a pair of framework members provided at respective end parts in a vehicle width direction and extending in a vehicle front-rear direction;
a cross member provided between the pair of framework members and extending in the vehicle width direction; and
a battery case disposed at a vehicle lower side of the cross member, in which:
the framework members include an upper inner wall portion facing the cross member in the vehicle width direction and a lower inner wall portion facing the battery case in the vehicle width direction, and
the upper inner wall portion is provided further toward an inner side in the vehicle width direction than the lower inner wall portion.

### ADDITIONAL NOTE 2

The vehicle framework structure of additional note 1, in which:
the upper inner wall portion is disposed at a gap from the cross member,
the lower inner wall portion is disposed at a gap from the battery case, and
the gap between the upper inner wall portion and the cross member is smaller than the gap between the lower inner wall portion and the battery case.

### ADDITIONAL NOTE 3

The vehicle framework structure of additional note 1 or 2, in which an inclined portion, inclined from a vehicle width direction outer side to a vehicle width direction inner side on progression toward a vehicle upper part, is provided between the upper inner wall portion and the lower inner wall portion.

### ADDITIONAL NOTE 4

The vehicle framework structure of additional note 3, in which an upper end part of the inclined portion is provided at a position that overlaps with a lower end part of the cross member as viewed from the vehicle width direction.

### ADDITIONAL NOTE 5

The vehicle framework structure of additional note 3 or 4, in which a lower end part of the inclined portion is positioned further toward a vehicle upper part than a terminal member of a battery housed inside the battery case.

What is claimed is:

1. A vehicle framework structure, comprising:
a pair of framework members provided at respective end parts in a vehicle width direction and extending in a vehicle front-rear direction;
a cross member provided between the pair of framework members and extending in the vehicle width direction; and
a battery case disposed at a vehicle lower side of the cross member, wherein:
the framework members include an upper inner wall portion facing the cross member in the vehicle width direction and a lower inner wall portion facing the battery case in the vehicle width direction, and
the upper inner wall portion is provided further toward an inner side in the vehicle width direction than the lower inner wall portion.

2. The vehicle framework structure of claim 1, wherein:
the upper inner wall portion is disposed at a gap from the cross member,
the lower inner wall portion is disposed at a gap from the battery case, and
the gap between the upper inner wall portion and the cross member is smaller than the gap between the lower inner wall portion and the battery case.

3. The vehicle framework structure of claim 1, wherein an inclined portion, inclined from a vehicle width direction outer side to a vehicle width direction inner side on progression toward a vehicle upper part, is provided between the upper inner wall portion and the lower inner wall portion.

4. The vehicle framework structure of claim 3, wherein an upper end part of the inclined portion is provided at a position that overlaps with a lower end part of the cross member as viewed from the vehicle width direction.

5. The vehicle framework structure of claim 3, wherein a lower end part of the inclined portion is positioned further toward a vehicle upper part than a terminal member of a battery housed inside the battery case.
